(19) United States
(12) Patent Application Publication
(10) Pub. No.: US 2010/0131365 A1
(43) Pub. Date: May 27, 2010

(54) Context-Sensitive Advertising for Mobile Content

(75) Inventors: Ravi R. Subramanian, Kirkland, WA (US); Scott Colville, Kirkland, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/277,603

(22) Filed: Nov. 25, 2008

(51) Int. Cl. G06Q 30/00

(52) U.S. Cl. 705/14.55

(57) ABSTRACT

Various embodiments provide context-sensitive advertising for content on a mobile device. In some embodiments, context information about a mobile device, a user of the device, and/or content to be consumed on the device is used to formulate an advertisement request. The advertisement request is submitted to an advertisement source, which gathers relevant advertisements that correspond to the context information. The relevant advertisements are provided to the mobile device, and one or more of the relevant advertisements are injected into content, by the mobile device, before the content is consumed by a user of the device. In some embodiments, an advertisement is marked with a sentinel marker when it is injected into content. When the content is to be sent from the device, the sentinel marker is detected and the marked advertisement is removed from the content before the content leaves the device.

### BACKGROUND

A mobile device can provide a user with a variety of different types of content, such as email, instant messaging, photographs, and so on. Advertisers often utilize content as a vehicle for presenting advertisements to users of mobile devices. For example, an email service may receive an advertisement (hereinafter “ad”) from an advertiser, and may embed the ad into an email before the email is downloaded onto a mobile device. When the email is downloaded to the mobile device and displayed to a user, the user will view the ad along with the content of the email. There are two primary disadvantages to this technique for providing ads with content.

First, a content provider that embeds an ad in content typically has little or no knowledge about the mobile device that is receiving the content, or the user of the mobile device. Accordingly, the ads received by the device as part of the content are usually very general in nature and do not take into consideration specific device configurations or information about the user of the device.

Second, when an ad is embedded into content at a content source, the original form of the content is altered by the addition of the ad. Thus, when content with an embedded ad is received by a mobile device, the content with the embedded ad is stored on the device. When the content is sent from the mobile device (e.g., when an email is forwarded), the ad will typically persist with the content. In the case of an evolving email thread, ad persistence can increase the size of an email and clutter the appearance of the email. Also, the ad may lose relevance over time (e.g., a weekend sale at a local merchant) such that the ad is irrelevant or annoying to a subsequent consumer of the content.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide context-sensitive advertising for content on a mobile device. In some embodiments, context information about a mobile device, a user of the device, and/or content to be consumed on the device is used to formulate an advertisement request. The advertisement request is submitted to an advertisement source, which gathers relevant advertisements that correspond to the context information. The relevant advertisements are provided to the mobile device, and one or more of the relevant advertisements are injected, on the mobile device, into content before the content is consumed by a user of the device. In some embodiments, an advertisement is marked with a sentinel marker when it is injected into content. When the content is to be sent from the device, the sentinel marker is detected and the marked advertisement is removed from the content before the content leaves the device.

### BRIEF DESCRIPTION OF THE DRAWINGS

The same numbers are used throughout the drawings to reference like features.

FIG. 1 illustrates a system in which various principles described herein can be employed in accordance with one or more embodiments.

FIG. 2 illustrates an example user interface in accordance with one or more embodiments.

FIG. 3 is a flow diagram describing steps in a method of providing context-sensitive advertising for content in accordance with one or more embodiments.

FIG. 4 is a flow diagram describing steps in a method of providing content-sensitive advertising for content in accordance with one or more embodiments.

FIG. 5 is a flow diagram describing steps in a method of gathering context-sensitive advertising for content in accordance with one or more embodiments.

FIG. 6 is a flow diagram describing steps in a method of dynamically retrieving context-sensitive advertising for content in accordance with one or more embodiments.

FIG. 7 is a flow diagram describing steps in a method of injecting ads into and removing ads from content in accordance with one or more embodiments.

FIG. 8 illustrates an example system that can be used to implement one or more embodiments.

### DETAILED DESCRIPTION

### Overview

Various embodiments provide context-sensitive advertising for content on a mobile device. Examples of content include an email, an instant message, a photograph, a contact file, and so on. In some embodiments, context information about a mobile device, a user of the device, and/or content to be consumed on the device is used to formulate an advertisement (hereinafter “ad”) request. The ad request is submitted to an ad source, which gathers relevant ads that correspond to the context information. The relevant ads are provided to the mobile device, and one or more of the relevant ads are injected, by the mobile device, into content before the content is consumed by a user of the device.

In some embodiments, an ad is marked with a sentinel marker when the ad is injected into content. When the content is to be sent from the device (e.g., when an email is going to be forwarded), the sentinel marker is detected and the marked ad is removed from the content before the content leaves the device.

In the discussion that follows, a section entitled “Operating Environment” is provided and describes one environment in which one or more embodiments can be employed. Following this, a section entitled “Example User Interface” is provided and describes a user interface that is configured to display context-sensitive advertising along with content. Next, a section entitled “Example Methods” is provided that discusses examples of methods that implement various techniques for providing context-sensitive advertising. Finally, a section entitled “Example System” is provided and describes an example system that can be used to implement one or more embodiments.

### Operating Environment

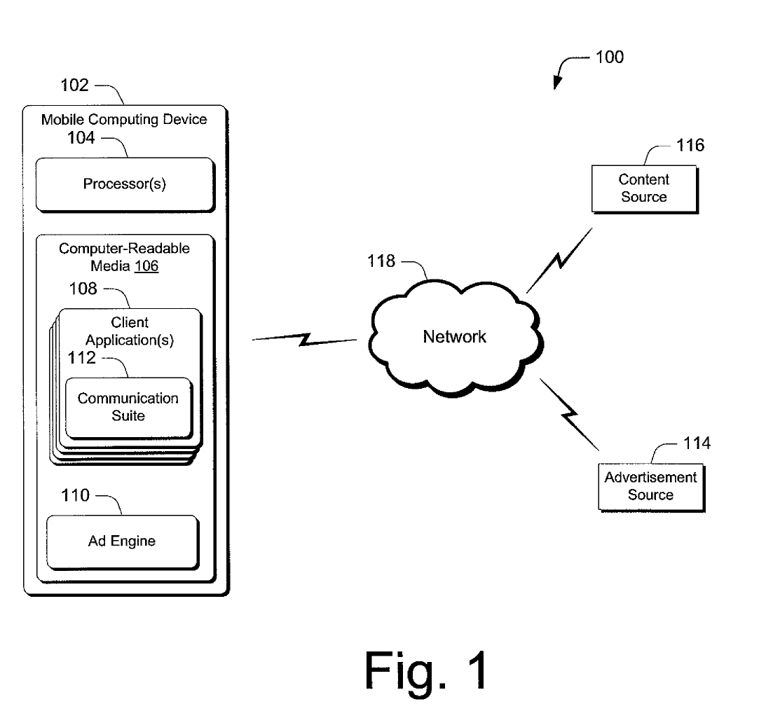

FIG. 1 illustrates an operating environment in accordance with one or more embodiments, generally at 100. Environment 100 includes a mobile computing device 102 having one or more processors 104 and one or more computer-readable media 106. Mobile computing device 102 can be embodied as any suitable mobile device such as, by way of example and not limitation, a handheld computer such as a personal digital assistant (PDA), a smart phone, a cell phone, a portable computer, and the like.

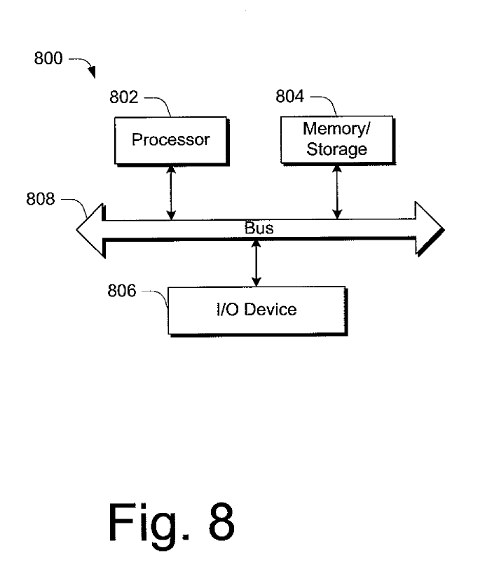

Residing on the computer-readable media and executable by the processor(s) are one or more client applications 108 and an ad engine 110. The computer-readable media can include, by way of example and not limitation, all forms of volatile and non-volatile memory and/or storage media that are typically associated with a computing device. Such media can include ROM, RAM, flash memory, hard disk, removable media and the like. One specific example of a mobile device is shown and described below in FIG. 8.

Examples of the client application(s) include an email application, an instant messaging application, a photograph viewer, a contacts application, a calendar application, a social networking application, and so on. One example of a contacts application is an application that stores and/or manages contact information (e.g., names, physical addresses, email addresses, and so on) for persons and/or other entities. In at least some embodiments, one or more of the client applications are configured to receive content from a content source and present the content in a form suitable for consumption by a user of the mobile device. In an email application example, the email application is configured to receive email from an email service and make the email available to be displayed on the mobile device.

In the context of a calendar application, events from a user's calendar can be used to determine temporally significant context information (e.g., holidays, vacations, recreational activities, and so on.) The temporally significant context information can be fed to the ad engine 110, which can retrieve ads that are relevant to the temporally significant context information. For example, if a user's calendar includes an event marked “Night at the Symphony”, one or more ads can be retrieved for the user that are relevant to the symphony and/or symphonic music.

The client application(s) also includes or otherwise makes use of a communication suite 112 that is configured to handle a variety of tasks for the client application. In some embodiments, the communications suite gathers context information about the mobile device and/or a user of the mobile device. For example, the communication suite may determine a user's current location using a GPS engine (not shown), cell location and the like. The communications suite may also inspect content for keywords and other context information specific to the content. In some embodiments, the communications suite is configured to forward the context information to the ad engine 110, receive ads from the ad engine, inject an ad into content, and remove an ad from content.

In one or more embodiments, the ad engine is configured to interface with the client application(s) and to receive context parameters from a client application. The ad engine is also configured to formulate an ad request that includes one or more of the parameters. Context parameters may include a variety of different information about the mobile device, such as its screen size, screen orientation (e.g., landscape or portrait), screen resolution, geographic location, media capabilities, battery level, memory capabilities, processing capabilities, calendar events (temporal significance revealing holidays, festivals, etc) and so on. Context parameters may also include a variety of different information about a user of the mobile device, such as web sites visited, instant messaging logs, call history, geographic location history, email content, contacts, and so on. The ad engine is configured to send the ad request to an ad source, such as advertisement (“ad”) source 114. In at least some embodiments, the ad source may be a remote resource that is remote from the mobile computing device. The ad source receives an ad request and gathers ads that correspond to one or more of the context parameters included in the ad request. The ad source may store ads locally and/or retrieve ads from a third-party resource.

Environment 100 also includes a content source 116 that is configured to provide content to the mobile device. Examples of the content source include, by way of example and not limitation, an email service, an instant messaging service, a photograph service, a web content service, and so on. In addition, environment 100 includes a network 118, such as the Internet, through which the various components of environment 100 may communicate and exchange information.

Having described an example operating environment, consider now a discussion of an example user interface in accordance with one or more embodiments.

### Example User Interface

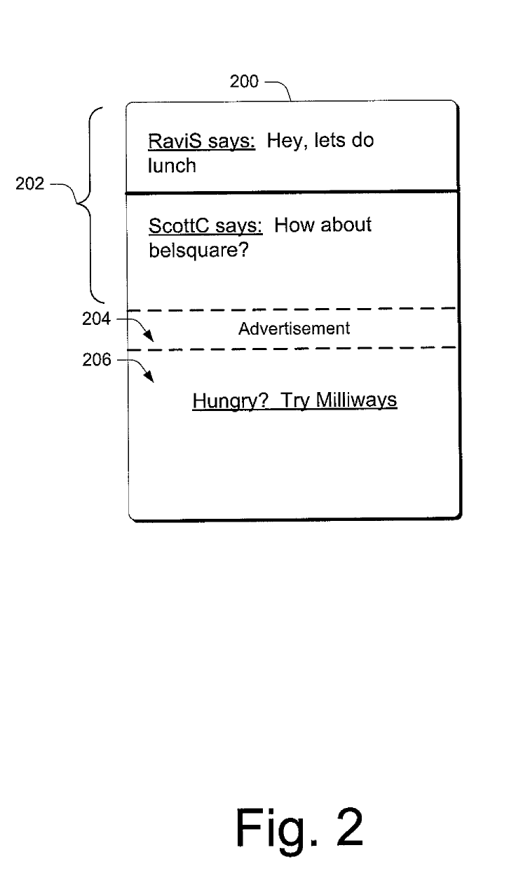

FIG. 2 illustrates, generally at 200, one example of a user interface that can be displayed on a mobile device and that can implement the techniques for providing relevant advertising discussed herein. The illustrated user interface is merely one example, and variety of different user interface configurations may be utilized without departing from the spirit and scope of the claimed embodiments.

The user interface may be associated with a variety of different client applications, examples of which are discussed above. Illustrated in this example user interface is a conversation between two individuals, RaviS and ScottC. The user interface includes a content region 202, an advertisement banner 204 and an ad region 206. The content region displays content such as text, images, web pages, video, and so on. The advertisement banner 204 indicates to a viewer that the ad region 206 immediately below the advertisement banner (i.e., the ad region) includes an ad.

In this example, an ad has been retrieved based on one or more context parameters and displayed in the ad region. The context parameters considered in this example may include keywords from the conversation (e.g., “lunch”, “belsquare”, and so on), and may also include mobile device-specific parameters and/or user-specific parameters. In this example, an ad for Milliways restaurant is displayed. Milliways may be a restaurant that serves lunch in the region of belsquare.

According to some embodiments, ads that are provided with content can be passive or active in nature. A passive ad simply conveys information, such as the name of a restaurant or other merchant, to a content consumer. An active ad enables a user to take a subsequent action by interacting with the ad. For example, an active ad may include a hyperlink which, if selected (e.g., by clicking on the ad), navigates a user to a website associated with the ad. The website may convey further information about a merchant and/or product associated with the original ad. In embodiments that involve a phone-enabled mobile device, when selected, an active ad may automatically dial a merchant or other party associated with the ad.

Having considered an example user interface, consider now some example methods in accordance with one or more embodiments.

### Example Methods

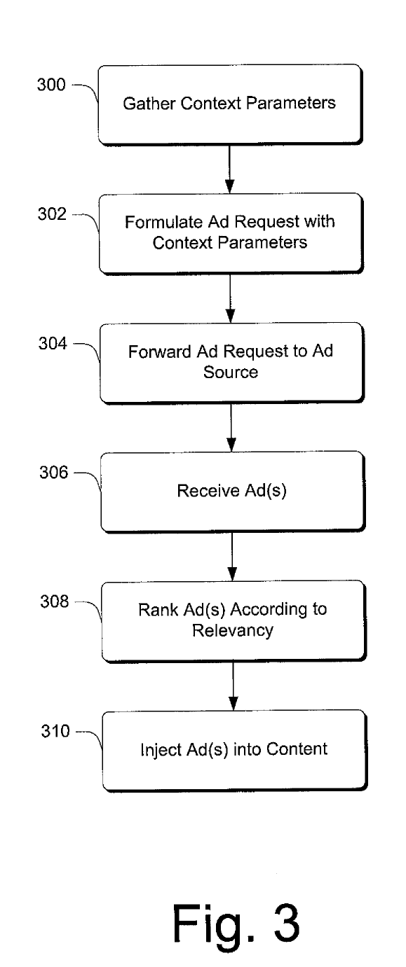

FIGS. 3-7 are flow diagrams that describe methods in accordance with one or more embodiments. The methods can be implemented in connection with any suitable hardware, software, firmware or combination thereof. In at least some embodiments, aspects of the methods can be implemented on a mobile device, such as mobile device 102. Some of the methods are illustrated with steps occurring at and/or being implemented by a client application or an ad engine. This is not intended to be limiting, however, and other implementations may perform the illustrated steps at different locations and/or utilizing different functionalities.

FIG. 3 is a flow diagram of one example method for using context parameters to provide relevant advertising for content on a mobile device. The various steps described below can be performed by a mobile device.

Step 300 gathers context parameters, such as device context parameters and/or user context parameters. Context parameters may be continually and/or periodically gathered and updated as device settings change (e.g., a change from portrait view to landscape view) and/or as user context changes (e.g., the user moves to a new geographic location). Also, in some embodiments, a change to one or more parameters may trigger an automatic ad request that corresponds to the parameter change(s). Step 302 formulates an ad request that includes the context parameters.

Step 304 forwards the ad request to an ad source, such as ad source 114 discussed in FIG. 1. In some embodiments, the ad request is forwarded to the ad source when a client application is opened or otherwise initiated on the mobile device. Alternately or additionally, an ad request can be forwarded when a context change occurs, such as a location change or device setting change. Step 306 receives one or more ads from the ad source. In at least some embodiments, step 308 ranks the ads according to each ad's relevancy to the context parameters. A variety of different ranking methods may be employed. For example, an ad that correlates to the greatest number of context parameters (e.g., the most keyword matches, the most device parameters, the most user parameters, or any other suitable ranking parameter) may be designated as the best match and may be provided first to be injected into content.

Step 310 injects one or more of the ads into content. In some embodiments, an ad with the highest rank may be considered the most relevant ad and thus can be selected to be injected into the content. The content may be presented with the ad(s) on a mobile device. Presenting content and/or an associated ad may include visual presentation and/or audio presentation.

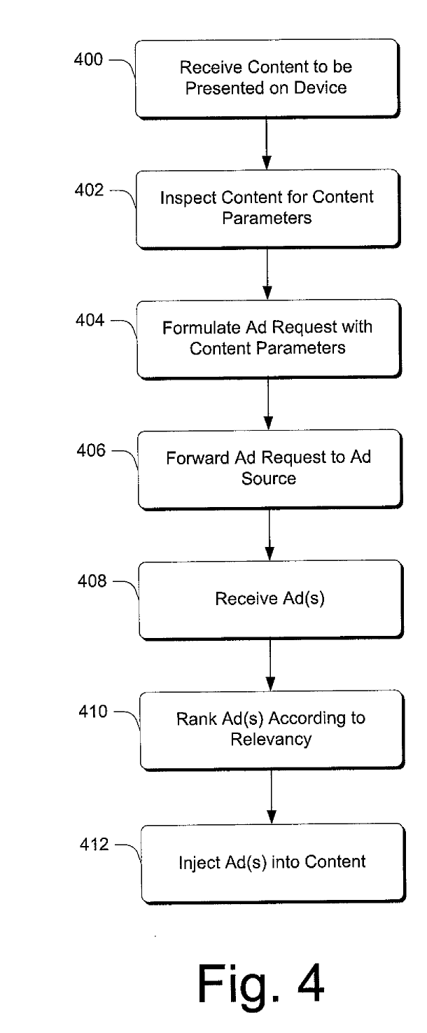

FIG. 4 is a flow diagram of one example method for using content parameters to provide relevant advertising for content on a mobile device. The various steps described below can be performed by a mobile device.

Step 400 receives content (e.g., an email message, an instant message, and the like) to be presented on a mobile device. Step 402 inspects the content for one or more content parameters. Content parameters may include keywords within the content, a content source, content geographical data (e.g., geotagging data), contacts associated the content (e.g., a person sending the content, a person receiving the content, and/or a person copied on the content), and so on.

Step 404 formulates an ad request that includes the content parameters. Step 406 forwards the ad request to an ad source. Step 408 receives one or more ads in response to the ad request. In at least some embodiments, step 410 ranks the ads according to their relevancy to the content parameters. Some suitable ways for ad ranking are discussed above. Step 412 injects one or more of the ads (e.g., in at least some embodiments, according to the highest rank) into content. The content and associated ad(s) may be displayed and/or otherwise presented on the mobile device.

This example method enables, in at least some embodiments, ads to be retrieved for content before a viewer selects the content to be presented. For example, when an email client application downloads an email from an email service, the application can immediately receive an ad from the ad engine and inject the ad into the email before a user selects the email to be viewed.

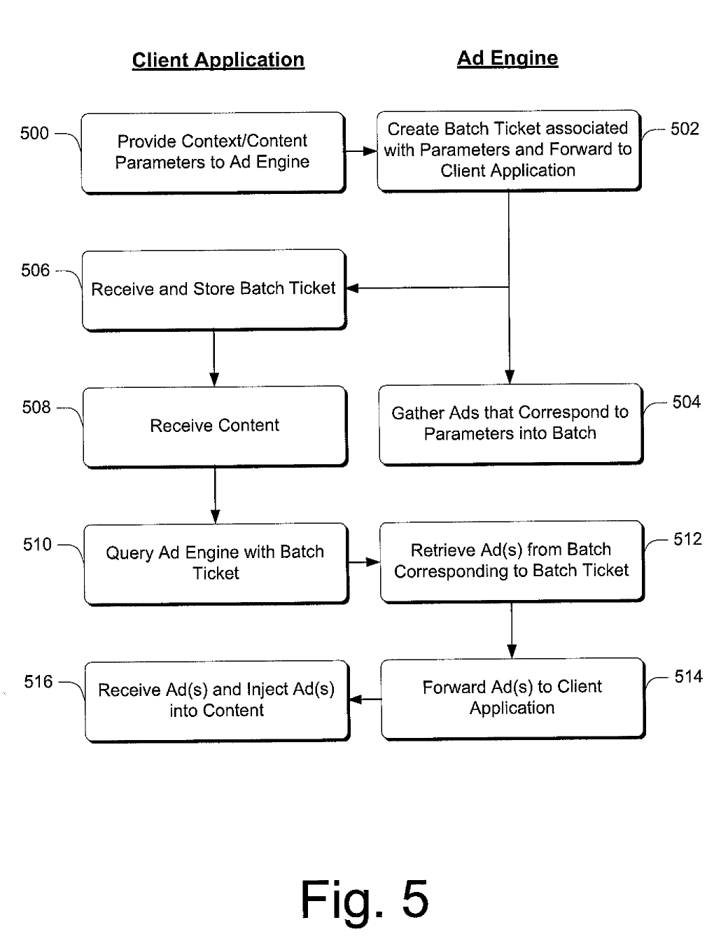

FIG. 5 is a flow diagram of one example method for providing relevant advertising for content. Various illustrated steps can be performed by a client application executing on mobile device. Likewise, other steps can be performed by a suitably-configured ad engine, such as the one illustrated and described above.

Step 500 provides one or more context and/or content parameters to the ad engine. Step 502 creates a batch ticket associated with the parameters and forwards the batch ticket to the client application. Step 504 gathers ads that correspond to the parameters into a batch (e.g., by submitting an ad request with the parameters to an ad source). The ads may be gathered immediately in response to receiving the content parameters from the client application, or the ads may be gathered asynchronously to generate the batch of ads.

Step 506 receives and stores the batch ticket. Step 508 receives content to be presented on a mobile device. Step 510 queries an ad engine for one or more ads using the batch ticket. The batch ticket serves as a reference to the parameters that were provided to the ad engine and is a callback mechanism for requesting an ad from the batch of ads that were gathered using the parameters. In some embodiments, the ad engine can generate and manage multiple distinct batches of ads for one or more client applications. Step 512 retrieves one or more ads from the batch of ads that corresponds to the batch ticket. Step 514 forwards the ad(s) to the client application. Step 516 receives the ad(s) and injects the ad(s) in the content. The content with its associated ad(s) may then be presented on the mobile device.

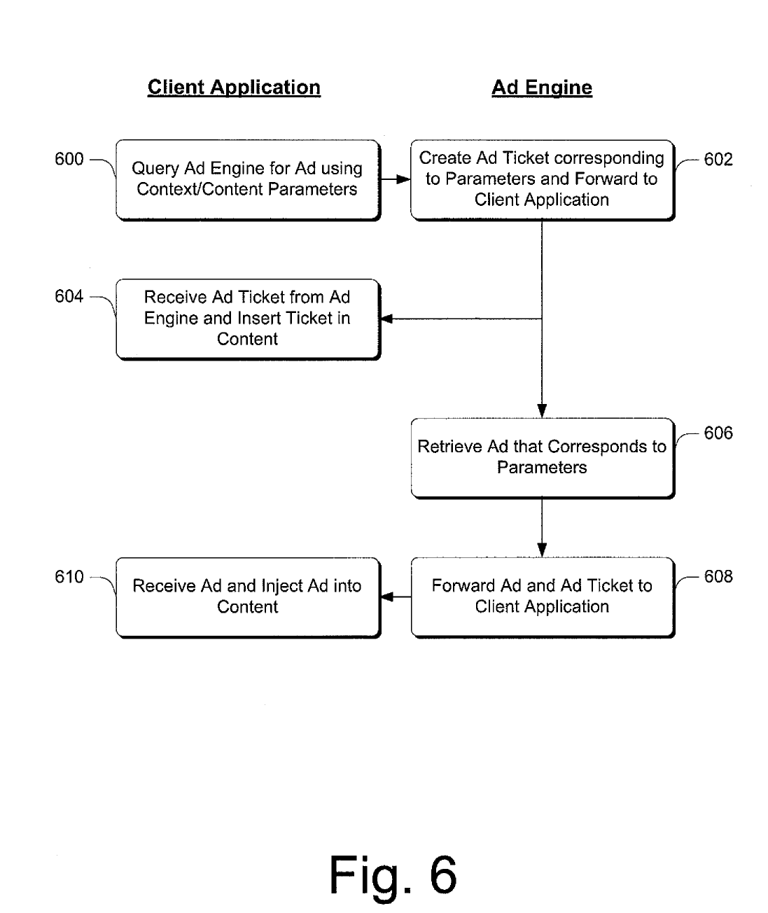

FIG. 6 is a flow diagram of one example method for providing dynamic retrieval and injection of one or more ads. Various illustrated steps can be performed by a client application executing on mobile device. Likewise, other steps can be performed by a suitably-configured ad engine, such as the one illustrated and described above. In one or more embodiments, this example method enables downloaded content that is not immediately viewed by a user (e.g., an email) to be provided to an ad engine to generate a batch of one or more ads asynchronously.

In some embodiments, the method may be implemented in response to receiving content at a mobile device that is to be presented on the device. Step 600 queries an ad engine for one or more ads and provides context parameters and/or content parameters to be used in retrieving the ad(s). Step 602 creates an ad ticket that corresponds to the parameters and forwards the ad ticket to the client application. Step 604 receives the ad ticket and inserts the ad ticket into the content as a placeholder for an ad.

Step 606 retrieves an ad that corresponds to the parameters. Step 608 forwards the ad and the ad ticket to the client application. Sep 610 receives the ad and injects the ad into the content to replace the placeholder ad ticket.

In one example implementation, the methods discussed above can be utilized to inject an ad into an HTML display of an instant messaging conversation. One example of a suitable HTML representation is presented below:

<html>
<body>
:
:
Conversation text history goes here
:
:
<!-- Permanent ad banner area at the bottom on a conversation window -->
<div id=“Unique_Service_Identifier”>
<div id=“ad ticket”/>
</div>
</body>
</html>

In the illustrated HTML, the “ad ticket” serves as a placeholder for an ad while the ad is being retrieved, and the ad ticket itself is not displayed to the user. When an ad is received that corresponds to the ad ticket, the ad ticket is replaced with the actual ad. This is illustrated in the HTML below, which illustrates in bold that the ad ticket is replaced with an ad and/or a link to an ad:

<html>
<body>
:
:
Conversation text history goes here
:
:
<!-- Permanent ad banner area at the bottom on a conversation window -->
<div id=“Unique_Service_Identifier”>
<img src=“http://some/advertisement/link” alt=“click here to
launch ad web site”/>
</div>
</body>

The content with the linked ad can be viewed by the user.

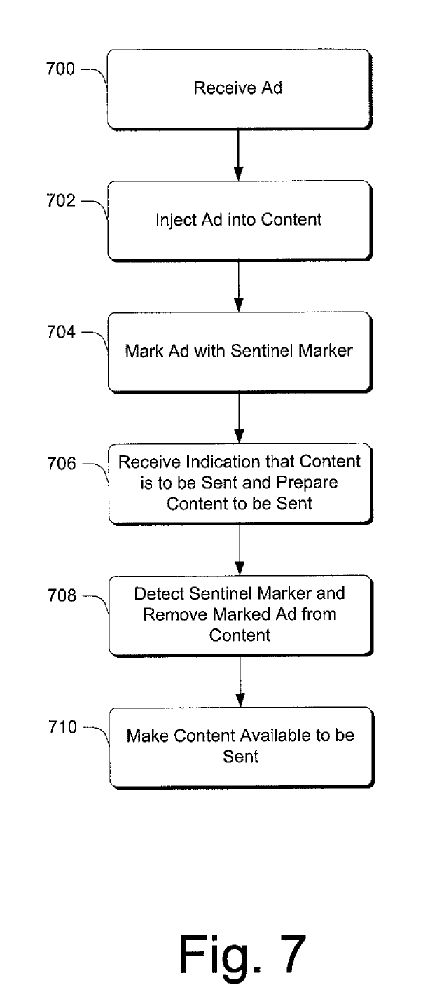

FIG. 7 is a flow diagram of one example method for tracking an ad that is injected into content in accordance with one or more embodiments. The method can be performed in connection with any suitable hardware, software, firmware or combination thereof. In at least some embodiments, the method can be performed by a suitably configured mobile device.

Step 700 receives an ad, for example, in response to an ad request. Step 702 injects the ad into content. In one example implementation, the content is an email message on a mobile device, and the ad is injected into the email message. Step 704 marks the ad within the content with a sentinel marker. In some embodiments, the sentinel marker comprises a piece of code or other pointer that identifies the ad as being distinct from the content.

Step 706 receives an indication that the content is to be sent and prepares the content to be sent. In the email message example presented above, the email message is prepared to be forwarded, replied to, or otherwise sent from the mobile device. Step 708 detects the sentinel marker in the content and removes the marked ad from the content. Step 710 makes the content without the ad available to be sent. By marking ads and removing ads from content before the content is sent, ads that are displayed are relevant to a particular device and/or user context, and stale ads are not propagated when content moves from user-to-user and location-to-location.

Having described techniques for providing relevant ads for content on a mobile device, consider now an example system that can be utilized to implement one or more of the above-described embodiments.

### Example System

FIG. 8 illustrates an example mobile computing device 800 that can implement the various embodiments described above. Mobile computing device 800 can be, for example, mobile device 102 of FIG. 1 or any other suitable mobile computing device.

Mobile computing device 800 includes one or more processors or processing units 802, one or more memory and/or storage components 804, one or more input/output (I/O) devices 806, and a bus 808 that allows the various components and devices to communicate with one another. Bus 808 represents one or more of any of several types of bus structures, including a memory bus or memory controller, a peripheral bus, an accelerated graphics port, and a processor or local bus using any of a variety of bus architectures. Bus 808 can include wired and/or wireless buses.

Memory/storage component 804 represents one or more computer storage media. Component 804 can include volatile media (such as random access memory (RAM)) and/or nonvolatile media (such as read only memory (ROM), Flash memory, optical disks, magnetic disks, and so forth). Component 804 can include fixed media (e.g., RAM, ROM, a fixed hard drive, etc.) as well as removable media (e.g., a Flash memory drive, a removable hard drive, an optical disk, and so forth).

One or more input/output devices 806 allow a user to enter commands and information to mobile computing device 800, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments provide context-sensitive advertising for content on a mobile device. In some embodiments, context information about a mobile device, a user of the device, and/or content to be consumed on the device is used to formulate an advertisement request. The advertisement request is submitted to an advertisement source, which gathers relevant advertisements that correspond to the context information. The relevant advertisements are provided to the mobile device, and one or more of the relevant advertisements are injected, by the mobile device, into content before the content is consumed by a user of the device. In some embodiments, an advertisement is marked with a sentinel marker when it is injected into content. When the content is to be sent from the device, the sentinel marker is detected and the marked advertisement is removed from the content before the content leaves the device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
gathering one or more context parameters on a mobile device;
forwarding an advertisement request to a remote resource, the advertisement request comprising at least one of the context parameters;
receiving, at the mobile device, an advertisement from the remote resource, the advertisement corresponding to the at least one of the context parameters in the advertisement request; and
injecting the advertisement into content that resides on the mobile device.

2. The method of claim 1, wherein the context parameters comprise information about one or more of the mobile device or a user of the mobile device.

3. The method of claim 1, wherein the context parameters comprise mobile device configuration information.

4. The method of claim 1, wherein gathering the plurality of context parameters comprises inspecting the content for context information about the content.

5. The method of claim 1, wherein the content comprises one or more of an email message, an instant messaging conversation, a photograph, a calendar item, or a contact.

6. The method of claim 1, wherein, responsive to receiving the advertisement from the resource, storing the advertisement in a batch of advertisements that correspond to the at least one of the context parameters in the advertisement request, and retrieving the advertisement from the batch of advertisements before it is injected into the content.

7. The method of claim 6, wherein at least some individual advertisements in the batch of advertisements are ranked according to relevance to context parameters, and wherein an injected advertisement is retrieved from the batch of advertisements based at least in part on its rank.

8. The method of claim 1, further comprising:
receiving an indication that content is to be sent from the mobile device; and
removing one or more advertisements from the content that is to be sent before the content is sent from the mobile device.

9. A mobile device comprising:
one or more processors;
one or more computer-readable storage media embodying software instructions which, when executed, implement a method comprising:
marking an advertisement with a sentinel marker;
injecting a marked advertisement into content on the mobile device;
receiving an indication that the content is to be sent from the mobile device;
detecting the sentinel marker in the content; and
removing, using the sentinel marker, the advertisement from the content before the content is sent from the mobile device.

10. The mobile device of claim 9, wherein the advertisement corresponds to one or more context parameters associated with the mobile device.

11. The mobile device of claim 10, wherein the context parameters comprise mobile device configuration information.

12. The mobile device of claim 10, wherein the context parameters comprise information about a user of the mobile device.

13. The mobile device of claim 9, wherein the content comprises one or more of an email message, an instant messaging conversation, a photograph, a calendar item or a contact.

14. A method implemented on a mobile computing device, the method comprising:
submitting a query for an advertisement, the query comprising one or more context parameters that are to be used to retrieve the advertisement;
receiving a ticket that references the query;
inserting the ticket into content that is to be presented on the mobile computing device;
retrieving the advertisement;
replacing the ticket with the advertisement within the content;
making the content and the advertisement available to be presented on the mobile computing device.

15. The method of claim 14, wherein the query is submitted by a client application, the client application comprising one or more of an email application, an instant messaging application, a contacts application, a calendar application, a photo application, or a social networking application.

16. The method of claim 15, wherein the query is submitted by a client application responsive to the client application receiving the content from a remote resource.

17. The method of claim 14, wherein the query is submitted responsive to a change to one or more of the context parameters.

18. The method of claim 14, wherein one or more of the context parameters are determined by inspecting the content, and wherein the advertisement corresponds to the content.

19. The method of claim 14, wherein the advertisement comprises an active advertisement which, if selected, enables a subsequent action to occur.

20. The method of claim 14, further comprising:
receiving an indication that the content is to be sent from the mobile computing device; and
removing the advertisement from the content before the content is sent from the mobile computing device.
